(19) United States
(12) Patent Application Publication
(10) Pub. No.: US 2005/0250890 A1
(43) Pub. Date: Nov. 10, 2005

(54) Filler masterbatch for thermoplastic compositions

(76) Inventors: Yan Chen, Canton, OH (US); John Myles, Fairlawn, OH (US); Ramesh Rengarajan, Princeton Junction, NJ (US); Bill Sparhawk, North Canton, OH (US)

Correspondence Address: THE FIRM OF HUESCHEN AND SAGE, SEVENTH FLOOR, KALAMAZOO BUILDING, 107 WEST MICHIGAN AVENUE, KALAMAZOO, MI, 49007, US

(21) Appl. No.: 11/122,722

(22) Filed: May 5, 2005

Related U.S. Application Data
(60) Provisional application No. 60/568,546, filed on May 6, 2004.

(51) Int. Cl. C08K 3/04; C08K 3/26; C08K 3/34

(52) U.S. Cl. 524/425; 524/451; 524/495; 524/492

(57) ABSTRACT

The present invention relates to a filler masterbatch composition comprised of a polymer selected from an impact polypropylene, a high density polyethylene, and a polyolefin elastomer and a mineral filler and a filled thermoplastic composition produced by combining such a filer masterbatch composition with a polymer. The inventive filler masterbatch allows for a higher compounding rate, better dispersion, and elimination of a typical compounding step in the production of filled thermoplastic compositions.

### FIELD OF THE INVENTION

The present invention relates to a filler masterbatch composition comprised of a polymer selected from an impact polypropylene, a high density polyethylene, and a polyolefin elastomer and a mineral filler and a filled thermoplastic composition produced by combining such a filler masterbatch composition with a polymer. The inventive filler masterbatch allows for a higher compounding rate, better dispersion, and elimination of a typical compounding step in the production of filled thermoplastic compositions.

### BACKGROUND OF THE INVENTION

Polyolefin compositions are widely used in numerous applications including molded articles and films. Various approaches have been used to improve the properties of polyolefin compositions, such as stiffness and scratch resistance, which are used in extrusion and injection molding applications. Filled polyolefin materials have been disclosed to be useful in a variety of areas, including automotive parts and are widely utilized in extrusion and injection molding processes. Incorporation of fillers into polyolefin compositions provides an economic benefit as well as improved properties.

Commercially available filler masterbatches have been used in a range of markets. For example, in the production of garment bags, a small amount of a filler masterbatch improves processing in manufacturing. Such masterbatches are simple in formulation and are typically used to simplify processing but not to impart any specific characteristics to the final product.

Masterbatch compositions comprising a crystalline polypropylene component with a bimodal molecular weight distribution and a xylene soluble ethylene copolymer component have also been disclosed (U.S. Pat. No. 6,586,531). The masterbatch compositions may include additives such as antioxidants, light stabilizers, heat stabilizers, nucleating agents, colorants, and fillers. Polyolefin compositions prepared from these masterbatch compositions are disclosed to be useful to produce injection molded articles, such as automobile bumpers, which exhibit a desirable balance of physical properties, including flexural modulus, impact resistance, and gloss, and reduced surface defects, such as tiger striping.

A method for the formation of a free flowing polymer/filler masterbatch powder comprised of a blend of a rubber polymeric material and a filler has been disclosed (U.S. Pat. No. 6,686,410). The method comprises intimately mixing in an internal mixer a rubber polymeric material and a filler wherein the volume loading of said internal mixer is in a range of from 25 to 71 percent for a time of from one to five minutes under shear conditions sufficient to convert the components into a free flowing associated composition of rubber polymeric material and filler. The free flowing composition is disclosed to be useful for making molded or extruded articles, such as tires, hoses, roof sheeting, weather-stripping, belts, wires, and cable covers.

Currently, traditional compounding processes are used to make mineral filled thermoplastic olefin compositions; however, if the mineral filler content exceeds 40%, current compounding processes do not provide sufficient dispersion of the filler in the polymer matrix. Moreover, such compounding processes require specialized equipment and are becoming cost prohibitive.

### THE PRESENT INVENTION

The present invention relates to a filler masterbatch composition comprised of a mineral filler and a polymer selected from an impact polypropylene, a high density polyethylene, and a polyolefin elastomer. The masterbatch composition of the present invention may be used directly in any polymer processing equipment, including dry blending the masterbatch with a polyolefin resin at the hopper of a polymer process machine or adding the masterbatch during the finishing process of a resin reactor to bypass the compounding process. The present invention further relates to a method for producing the filler masterbatch composition.

The filler masterbatch of the present invention may be produced by melt blending a mineral filler and a polymer selected from an impact polypropylene, a high density polyethylene (HDPE), and a polyolefin elastomer using compounding equipment, such as a Banbury mixer, a Farrel continuous mixer (FCM), a twin screw extruder, or a single screw extruder, with optimized designs to improve dispersion. Suitable mineral fillers include talc, calcium carbonates, carbon black, mica, silica, and nanocomposites.

The filler masterbatch may further include a low molecular weight dispersing agent which will improve the dispersion of the filler when the filler masterbatch is added to a TPO resin. The dispersing agent may also act as a release agent. Suitable dispersing agents include waxes and metal salts.

The filler masterbatch may further include colorants, such as carbon black, pigments, specialty coated micas, aluminum flake, or dyes.

The filler masterbatch composition may also be enhanced with stabilizers and process aids. These stabilizers and chemical modifiers improve the long term performance of the compositions and will not interfere with the performance of the compositions. Modifiers include ultraviolet absorbers, hindered amine light stabilizers, secondary phosphites, antioxidants, and internal process aids, such as lubricants.

The level and type of fillers and additives may be chosen to enhance the properties of the masterbatch itself and/or to enhance the properties of the final polymer products produced using the masterbatch. A filler masterbatch composition which includes colorants and additives such as stabilizers, UV additives, and slipping agents may function as a filler masterbatch as well as a color and/or an additive masterbatch (e.g., the masterbatch may provide enhanced color and/or stability properties to a final polymer product). Therefore, such a masterbatch may be described as a bi-functional or tri-functional masterbatch depending on the type of colorants and/or additives.

The filler masterbatch may be dry blended with a polymer resin (e.g., a thermoplastic olefin composition) and then subjected to any of the following processes: injection molding, blow molding, cast film, profile extrusion, cast sheet, and post thermoforming.

The filler masterbatch may be re-dispersed (using a melt blending process) with a thermoplastic polyolefin composition (i.e., a let down resin). By selecting an appropriate let down resin or combination of let down resins, products (including automotive components) which meet various original equipment manufacturer (OEM) plastic material specifications may be produced. Moreover, by choosing an appropriate combination of filler masterbatch and let-down resin, a final product exhibiting the same quality and properties may be produced using a single screw or a twin screw extruder.

The filler masterbatch composition may also be introduced to the finishing process of a reactor stream to produce a range of products which meet various OEM specifications. Such a process allows a broad range of products to be produced by adjusting a combination of the masterbatch loading and reactor formulation/process.

Use of the filler masterbatch of the present invention in the manufacture of filled thermoplastic olefins provides material with a balance between stiffness and low temperature impact, increases the heat deflection temperature, and reduces the mold shrinkage and the coefficient of linear thermal expansion of a final article. The TPO compositions produced using the filler masterbatch exhibit improved properties such as higher loading level and better dispersion of filler, improved hardness, improved impact resistance, and improved scratch resistance. For automotive applications, certain fillers may provide a reduction in final part weight. Using profile extrusion techniques, the present filler masterbatch compositions may be combined with thermoplastic resins to provide high mineral filled material with a high stiffness. Resins which exhibit high stiffness and high impact, such as the resin of Example 10 below, may be used to replace rigid PVC.

Thus, the filler masterbatch compositions of the present invention may be utilized with a variety of low-cost thermoplastic polyolefins, using processes which do not require a traditional compounding step, to produce a variety of products which previously required a separate, as well as costly, compounding step.

### SUMMARY OF THE INVENTION

What we therefore believe to comprise our invention may be summarized inter alia in the following words:

A filler masterbatch composition comprising a mineral filler and a polymer selected from an impact polypropylene, a high density polyethylene, and a polyolefin elastomer.

Such a filler masterbatch composition, wherein the mineral filler is selected from talc, calcium carbonates, carbon black, mica, silica, and nanocomposites.

Such a filler masterbatch composition, wherein the filler content is from 20-90% by weight.

Such a filler masterbatch composition, wherein the polymer is a polyolefin elastomer.

Such a filler masterbatch composition, wherein the polyolefin elastomer is a thermoplastic elastomer.

Such a filler masterbatch composition, wherein the polymer is an ultra high impact polypropylene.

Such a filler masterbatch composition, wherein the polymer is a high density polyethylene.

Such a filler masterbatch composition, wherein the polymer content is from 20-90% by weight.

Such a filler masterbatch composition, further comprising a dispersing agent.

Such a filler masterbatch composition, wherein the dispersing agent is a wax or a metal salt.

Such a filler masterbatch composition, wherein the dispersing agent content is from 0.15-5% by weight.

Such a filer masterbatch composition, further comprising a process stabilizer.

Such a filler masterbatch composition, further comprising an antioxidant.

Such a filler masterbatch composition, wherein the antioxidant content is from 0.1-11% by weight.

Such a filler masterbatch composition, further comprising a UV additive.

Such a filler masterbatch composition, wherein the UV additive content is from 2-10% by weight.

Such a filler masterbatch composition, further comprising a colorant such as carbon black, pigments, specialty coated micas, aluminum flake, and dyes.

Such a filler masterbatch composition, wherein the composition comprises about 20% to 90% mineral filler, about 20% to 90% thermal plastic elastomer, about 0.15% to 5% dispersing agent, and about 0.1-11% antioxidant.

Such a filler masterbatch composition, wherein the composition comprises about 20% to 90% mineral filler, about 20% to 90% ultra high impact polypropylene, about 0.15% to 5% dispersing agent, about 0.1-11% antioxidant, and about 2 to 10% UV additives.

Such a filler masterbatch composition, wherein the composition comprises about 20% to 90% mineral filler, about 20% to 90% high density polyethylene, about 0.15% to 5% dispersing agent, and about 0.1-11% antioxidant.

A process for producing a filler masterbatch composition, comprising melt blending a polymer, mineral filler, and, optionally, a dispersing agent, colorant, stabilizer, and/or process aid.

A process for producing a filled thermoplastic olefin composition, comprising blending a filler masterbatch comprising a mineral filler and a polymer selected from an impact polypropylene, a high density polyethylene, and a polyolefin elastomer with a thermoplastic olefin composition.

Such a process, wherein the masterbatch composition and the thermoplastic olefin are melt blended.

Such a process, wherein the masterbatch composition and the thermoplastic olefin are in-line compounded.

Such a process, wherein the process is carried out using a single screw or twin screw extruder.

Such a process, wherein the masterbatch composition and the thermoplastic olefin are dry blended and then subjected to a process which is carried out using polymer conversion equipment selected from injection molding, blow molding, cast film, profile extrusion, cast sheet, and post thermoforming equipment.

A process for producing a filled thermoplastic olefin composition, comprising blending a first filler masterbatch composition comprising a mineral filler and a polymer selected from an impact polypropylene, a high density polyethylene, and a polyolefin elastomer and a second filler masterbatch composition comprising a mineral filler; a polymer selected from an impact polypropylene, a high density polyethylene, and a polyolefin elastomer; a colorant; and additives selected from UV additives, UV stabilizers, and mixtures with a thermoplastic olefin composition.

### EXPERIMENTAL PART

The filler masterbatch compositions and their preparation of the present invention will be better understood in connection with the following examples, which are intended as an illustration of and not a limitation upon the scope of the invention.

### Example 1

A Banbury mixer was charged with Engage® 8100, Luzenac® R-7 Talc, Irganox® B225, and calcium stearate. The mixing unit was heated to 95-105° F., and the material was mixed for a sufficient amount of time to yield a filler masterbatch composition (MB1, comprised of 45.75% Engage® 8100, 54.0% Luzenac® R-7 Talc, 0.100% Irganox® B225, and 0.150% calcium stearate) with the properties reported in Table 1.

TABLE 1

| | |
|---|---|
| Specific Gravity | 1.35 |
| Moisture (ppm) | 400 |
| | max |
| Melt Index (230° C., 2.16 kg) | <2 |
| Ash Content | >50 |

### Example 2

A Banbury mixer was charged with BP Amoco Acctuf® 3045 ultra high impact copolymer, Luzenac® R-7 Talc, Irganox® B225, Tinuvin® 770 DF, and Chimasorb® 944 FD. The mixing unit was heated to 295-305° F., and the material was mixed for a sufficient amount of time to yield a filler masterbatch composition (MB2, comprised of 45.0% BP Amoco Acctuf® 3045 ultra high impact copolymer, 50.0% Luzenac® R-7 Talc, 1.0% Irganox® B225, 2.0% Tinuvin® 770 DF, and 2.0% Chimasorb® 944 FD) with the properties reported in Table 2.

TABLE 2

| | |
|---|---|
| Specific Gravity | 1.32-1.34 |
| Moisture (ppm) | 100 |
| | max |
| Melt Index (230° C., 2.16 kg) | <1.0 |
| Ash Content | 48-50 |

### Example 3

A Banbury mixer was charged with Equistar Altathon® HDPE H6030, Luzenac® R-7 Talc, calcium stearate, and Irganox® B225. The mixing unit was heated to 145-155° F., and the material was mixed for a sufficient amount of time to yield a filler masterbatch composition (MB3, comprised of 38.9% Equistar Altathon® HDPE H6030, 60.0% Luzenac® R-7 Talc, 1.0% calcium stearate, and 0.100% Irganox® B225) with the properties reported in Table 3.

TABLE 3

| | |
|---|---|
| Specific Gravity | 1.50 |
| Moisture (ppm) | 100 |
| | max |
| Melt Index (230° C., 2.16 kg) | 16.5 |
| Ash Content | 60 |

### Example 4

An FCM mixer was charged with Formosa Formolene® 6501 A, Luzenac® R-7 Talc, calcium stearate, and Irganox® B225. The mixing unit was heated to 450-480° F., and the material was mixed for a sufficient amount of time to yield a filler masterbatch composition (PMB-1, comprised of 29.4% Formosa Formolene® 6501A, 70.0% Luzenac® R-7 Talc, 0.2% calcium stearate, and 0.4% Irganox® B225).

### Example 5

An FCM mixer was charged with Formosa Formolene® 6501 A, IMI FABI Benwood Talc 2207, calcium stearate, and Irganox® B225. The mixing unit was heated to 450-480° F., and the material was mixed for a sufficient amount of time to yield a filler masterbatch composition (PMB-2, comprised of 29.4% Formosa Formolene® 6501A, 70.0% IMI FABI Benwood Talc 2207, 0.2% calcium stearate, and 0.4% Irganox® B225).

### Example 6

An FCM mixer was charged with Formosa Formolene® 6501 A, IMI FABI Benwood Talc 2207, calcium stearate, and Irganox® B225. The mixing unit was heated to 450-480° F., and the material was mixed for a sufficient amount of time to yield a filler masterbatch composition (PMB-3, comprised of 49.4% Formosa Formolene® 6501A, 50.0% IMI FABI Benwood Talc 2207, 0.2% calcium stearate, and 0.4% Irganox® B225).

### Example 7

An FCM mixer was charged with Formosa Formolene® 6501 A, Luzenac® R-7 Talc, calcium stearate, and Irganox® B225. The mixing unit was heated to 450-480° F., and the material was mixed for a sufficient amount of time to yield a filler masterbatch composition (PMB4, comprised of 19.4% Formosa Formolene® 6501A, 80.0% Luzenac® R-7 Talc, 0.2% calcium stearate, and 0.4% Irganox® B225).

### Example 8

An FCM mixer was charged with Formosa Formolene® 6501 A, Luzenac® R-7 Talc, calcium stearate, and Irganox® B225. The mixing unit was heated to 450-480° F., and the material was mixed for a sufficient amount of time to yield a filler masterbatch composition (PMB-5, comprised of 49.4% Formosa Formolene® 6501A, 50.0% Luzenac® R-7 Talc, 0.2% calcium stearate, and 0.4% Irganox® B225).

### Example 9

The masterbatch composition of Example 1 (MB1, 26%) was combined with a product as discharged from a polypropylene reactor and melt blended in a finishing process extruder of a reactor process stream to meet OEM specifications. The resulting filled material exhibited the properties shown in Table 4.

TABLE 4

| | | | | polypropylene |
|---|---|---|---|---|
| | | | Target | in-line |
| | | | OEM | compounded |
| Property | Test Method | Units | Specifications | with 26% MB1 |
| Melt Flow Rate | ASTM D1238, | g/10 | | 13.6 |
| | 230/2.16 | min | | |
| Specific Gravity | ASTM D792 | | 0.95-1.08 | 0.994 |
| Mineral Filled | ASTM D2584 | % | 11-21 | 12.8 |
| Tensile at Yield | ASTM D638, | MPa | | 20.3 |
| | 50 mm/min | | | |
| Flexural Modulus | ASTM D790, | MPa | 900-1500 | 1425 |
| | 1.3 mm/min, tangent | | | |
| Multiaxial impact | ASTM D3763, 2.2 | J | 100% Ductile | 100% |
| strength at −30° C. | m/sec | | 15 min | Ductile |
| | (Energy at max load) | | | 23.4 |
| | ASTM D3763, 6.6 m/sec | J | | 100% |
| | | | | D |
| | (Energy at max load) | | | 23 |
| Heat Deflection Temp. | ASTM D648, 455 kPa | ° C. | | 104.4 |
| Heat Deflection Temp. | ASTM D648, 1820 kPa | ° C. | | 55.1 |
| Mold Shrinkage | 48 hours after molding | % | | 0.9675 |

### Example 10

The masterbatch composition of Example 2 (MB2) was extruded with Basell Profax® SG 722 or Dow® D114 to provide a filled material exhibiting high stiffness and high impact. The properties of the resulting material are reported in Table 5.

TABLE 5

| | | | 80% MB2 and | 80% MB2 and |
|---|---|---|---|---|
| | | | redispersed | redispersed |
| | | | in 20% Basell | in 20% Dow |
| Property | Test Method | Units | SG722 | D114 |
| Melt Flow Rate | ASTM D1238, 230 C., | g/10 | 2.3 | 0.79 |
| | 2.16 Kg | min | | |
| Specific Gravity | ASTM D792 | | 1.23 | 1.23 |
| Tensile strength at | ASTM D638, Type I | MPa | 27.2 | 26 |
| Yield | bar, 50 mm/min | | | |
| Flexural Modulus | ASTM D790 | MPa | 3594.7 | 3240 |
| Flexural Strength | 1.3 mm/min, tangent | MPa | 43.9 | 42 |
| Notched Izod impact | ASTM D256 | J/m | 61.8 | 217 |
| @ 23° C. | | | | |
| Hardness, Rockwell R | ASTM D785 | R | 78.1 | 75 |
| Mold Shrinkage | ASTM D955 | % | 0.6 | 0.7 |
| | 96 hours after molding | | | |

### Example 11

Blow molding trials were conducted with the masterbatch composition of Example 2 (MB2). The masterbatch composition was dry blended with a variety of thermoplastic olefins (let down resins). The target specifications and testing methods are shown in Table 6. The properties of the resulting blow molded products are reported in Table 7.

TABLE 6

| | | | Target OEM |
|---|---|---|---|
| Property | Test Method | Units | Specifications |
| Density | ISO 1183 | g/cm³ | 0.96-1.04 |
| Mineral filler | | % | 10-16 |
| MFR | ISO 1133 | g/10 | 0.2-0.8 |
| | | min. | |
| Hardness | ISO 868, 15 | | 65 |
| | sec. Dwell | | |
| Tensile Yield | ISO 527R, | MPa | 28 |
| MPa, Min. | 50 mm/min | | |
| Elongation at | ISO 527R, | % | min. 25 |
| break | 50 mm/min | | |
| Flexural Modulus | ISO 178, | Gpa | 1.75 |
| GPa, Min. | 2 mm/min. | | |
| | Chord Mod. | | |
| Notched Izod | ISO 180/1A | KJ/m², | 15 |
| impact @ 23° C. | | min | |
| Notched Izod | ISO 180/1A | KJ/m², | 1.5 |
| impact @ −40° C. | | min | |
| HDT, ° C., | ISO 75, | ° C. | 56 |
| Min 1.80 MPa | edgewise | | |
| HDT, ° C., | ISO 75, | ° C. | 100 |
| Min 0.45 MPa | edgewise | | |
| Shrinkage (48 | 5″ × 7″ × ⅛″ | % | 1.5 |
| hrs after | plaque | | |
| molding) | | | |
| CLTE (with | ASTM E831, | E-05/° C. | 5.6 |
| flow) | −30° to +30° C. | | |

TABLE 7

| | | Let Down Resin | | | | | |
|---|---|---|---|---|---|---|---|
| | | 70% | 70% | | 70% | 70% | 70% |
| | | SunocoTI | Formosa | 70% | Basell | Basell | Basell |
| | | 4005F | PP6501A | Dow114 | 7823 | 7624 | 6823 |
| | | Filler Masterbatch | | | | | |
| | Target | 30% | 30% | 30% | 30% | 30% | 30% |
| | OEM | MB2 | MB2 | MB2 | MB2 | MB2 | MB2 |
| Property (units) | Specifications | Blend 1 | Blend 2 | Blend 3 | Blend 4 | Blend 5 | Blend 6 |
| Density (g/cm³) | 0.96-1.04 | nd | nd | nd | nd | nd | nd |
| Mineral filler (%) | 10-16 | 13.4 | 13.7 | 13.8 | 15.4 | 14 | 13.8 |
| MFR (g/10 min) | 0.2-0.8 | 0.59 | 0.65 | 0.53 | 0.56 | 1.06 | 0.54 |
| Hardness | 65 | 66.4 | 65.3 | nd | nd | nd | nd |
| Tensile Yield MPa, Min. | 28 | 30.4 | 29.1 | 30.1 | 28.6 | 30.5 | 36.8 |
| (MPa) | | | | | | | |
| Elongation at break (%) | min. 25 | 236 | 300 | 185 | 377 | 124 | 102 |
| Flexural Modulus GPa, | 1.75 | 2.35 | 2.2 | 2.4 | 2.6 | 2.81 | 2.57 |
| Min. (GPa) | | | | | | | |
| Notched Izod impact @ | 15 | 37.8 | 45.5 | 41.2 | 57.9 | 38 | 17 |
| 23° C. (KJ/m², min) | | | | | | | |
| Notched Izod impact @ | 1.5 | 4.3 | 3.7 | 4.4 | 5 | 3.8 | 3 |
| −40° C. (KJ/m², min) | | | | | | | |
| HDT, ° C., Min 1.80 MPa | 56 | 55 | 55 | 58.1 | 58 | 54.9 | 57.2 |
| (° C.) | | | | | | | |
| HDT, ° C., Min 0.45 MPa | 100 | 101 | 107.2 | 106.4 | 106.6 | 113.9 | 117.2 |
| (° C.) | | | | | | | |
| Shrinkage (48 hrs after | 1.5 | 1.43 | 1.18 | nd | nd | nd | nd |
| molding) (%) | | | | | | | |
| CLTE (with flow) (E-05/° C.) | 5.6 | 5.01 | 6.08 | 5.15 | 4.26 | nd | nd |

### Example 12

Blow molding trials were conducted with the masterbatch compositions of Examples 4-8. The masterbatch compositions were dry blended with a variety of thermoplastic olefins (let down resins). The target specifications and testing methods are shown in Table 6. The properties of the resulting blow molded products are reported in Table 8.

TABLE 8

| | | Let Down Resin | | | | | | |
|---|---|---|---|---|---|---|---|---|
| | | | | | | 70% | | |
| | | | | | | Basell | | |
| | | 70% | 70% | 78% | 80% | 6823/ | 70% | 78% |
| | | Basell | Basell | Basell | Basell | 8% Basell | Basell | Basell |
| | | 6823 | 6823 | 7823 | 7823 | 7823 | 7823 | 7823 |
| | | Filler Masterbatch | | | | | | |
| | | 30% | 30% | 22% | 20% | 22% | 30% | 22% |
| | Target | MB2 | PMB-5 | PMB-1 | PMB-4 | PMB-1 | PMB-3 | PMB-2 |
| | OEM | Blend | Blend | Blend | Blend | Blend | Blend | Blend |
| Property (units) | Specifications | 7 | 8 | 9 | 10 | 11 | 12 | 13 |
| Density (g/cm³) | 0.96-1.04 | nd | nd | nd | nd | nd | nd | nd |
| Mineral filler (%) | 10-16 | 13.8 | 13.2 | 15.6 | 15.8 | 14.8 | 15.5 | 14.4 |
| MFR (g/10 min) | 0.2-0.8 | 0.54 | nd | nd | nd | nd | nd | nd |
| Tensile Yield MPa, Min. | 28 | 36.8 | nd | nd | nd | nd | nd | nd |
| (MPa) | | | | | | | | |
| Elongation at break (%) | min. 25 | 102 | nd | nd | nd | nd | nd | nd |
| Flexural Modulus GPa, | 1.75 | 2.57 | 2.76 | 2.54 | 2.61 | 2.87 | 2.33 | 2.29 |
| Min. (GPa) | | | | | | | | |
| Notched Izod Impact @ | 15 | 17 | 18.9 | 36.6 | 32.8 | 15.2 | 24.8 | 25.5 |
| 23° C. (KJ/m², min) | | | | | | | | |
| Notched Izod Impact @ | 1.5 | 3 | 2.5 | 3.33 | 3 | 2.2 | 2.92 | 3.2 |
| −40° C. (KJ/m², min) | | | | | | | | |
| HDT, Min. 1.80 MPa (° C.) | 56 | 57.2 | 59.6 | 56.9 | 55.8 | 59.6 | 54.9 | 54.6 |
| HDT, Min. 0.45 MPa (° C.) | 100 | 117.2 | 144.5 | 109.2 | 111.6 | 116 | 104.7 | 101.1 |
| Shrinkage (48 hrs after | 1.5 | nd | nd | nd | nd | nd | nd | nd |
| molding) (%) | | | | | | | | |

### Example 13

The masterbatch composition of Example 3 (MB3, 32% by weight) was combined with a blend of BP Amoco Acctuf® 3541 (30.5%) and Sunoco TI 5350 (35%) and erucamide (0.5%) to meet OEM specifications. The resulting filled material exhibited improved scratch and mar resistance as well as the properties reported in Table 9.

TABLE 9

| | | | Target | |
|---|---|---|---|---|
| | | | OEM | |
| Property | Test Method | Units | Specifications | Product |
| Specific Gravity | ASTM D792 | | 1.02-1.08 | 1.05 |
| Mineral Filler (%) | ASTM D2584 | % | 19-24 | 19 |
| Tensile at Yield | ASTM D638 | Mpa | 18 | 20 |
| (Mpa) | | | | |
| Flexural Modulus | ASTM D790 | Mpa | 1700-2200 | 1872 |
| (Mpa) | | | | |
| Multiaxial Impact | ASTM D3763 | J | 12 | 18 |
| Energy to max | | | 100% | 100% |
| load 23° C., | | | Ductile | Ductile |
| 6.7 m/sec | | | | |

### Example 14

The masterbatch composition of Example 1 (MB1, 20% by weight) was combined with BP Amoco Acctuf® 3541 (80%) to meet OEM specifications. The resulting filled material exhibited the properties reported in Table 10.

TABLE 10

| | | | Target | |
|---|---|---|---|---|
| | | | OEM | Final |
| Property | Test Method | Units | Specifications | Product |
| Melt Flow Rate | ISO 1133 | g/10 min | | 14.6 |
| Specific | ISO 1183 | | 0.9-1.0 | 0.958 |
| Gravity | | | | |
| Ash Content | ISO 3451 | % | 6-13 | 10 |
| Tensile at | ISO 527, | MPa | 16 min | 18 |
| Yield | 5 mm/min | | | |
| Flex Modulus | ISO 178, | MPa | 1100-1700 | 1230 |
| | 2 mm/min, | | | |
| | Chord | | | |
| MAI at | ASTM D3763, | J | 15 min | 100% |
| 23° C. | 6.6 m/sec | | | Ductile |
| | (Energy at | | | 18 |
| | max load) | | | |
| MAI at | ASTM D3763, | J | 15 min | 100% |
| −30° C. | 6.6 m/sec | | | Ductile |
| | (Energy at | | | 24.7 |
| | max load) | | | |
| Notched Izod | ISO 180 | KJ/m² | 35 min | 45.2 |
| Heat Deflection | ISO 75 @ | ° C. | 70 min | 77 |
| Temp. | 455 Kpa | | | |

### Example 15

The masterbatch composition of Example 1 (MB1, 25% by-weight) was combined with a blend of Sunoco TI4900 (34%), ExxonMobil LL 5252.09 (26%), and Basell Hifax® 7320XEP (15%) to meet OEM specifications. The resulting filled material exhibits the properties shown in Table 11.

TABLE 11

| | | | Target | | |
|---|---|---|---|---|---|
| | | | OEM | | Final |
| Property | Test Method | Units | Specifications | | Product |
| Melt Flow Rate | ISO 1133 | g/10 min | 24-26 | | 24 |
| Specific Gravity | ISO 1183 | | 1.02 | max | 0.98 |
| Flex Modulus | ISO 178, Chord | MPa | 900-1100 | | 966 |
| MAI at 23° C. | ASTM D3763, 2.2 m/sec | J | 15 | min | 100% Ductile |
| | (Energy at max load) | | | | 16 |
| MAI at −30° C. | ASTM D3763, 2.2 m/sec | J | 15 | min | 100% Ductile |

| | (Energy at max load) | | | 20 |
|---|---|---|---|---|
| Mold Shrinkage | 48 hours after molding | in/in | 0.525-0.675 | 0.59 |
| | 4″ × 4″ × ⅛″ plaque | | | |
| | 1 hour at 121° C. | in/in | 0.725-0.875 | 0.74 |
| | 4″ × 4″ × ⅛″ plaque | | | |
| CLTE | ASTM E831 −30° C. to 100° C. | E-05/° C. | no spec. | 5.6 |
| *Must be paintable | | | | Paintable |

### Example 16

The masterbatch composition of Example 1 (MB1, 40% by weight) was combined with a blend of BP Amoco Accpro® 9965 (25%), BP Amoco Acctuf® 3541 (15%), and ExxonMobil LL 5252.09 (20%) to meet OEM specifications. The resulting filled material exhibited the properties reported in Table 12.

TABLE 12

| | | | Target | |
|---|---|---|---|---|
| | | | OEM | Final |
| Property | Test Method | Units | Specifications | Product |
| Melt Flow Rate | ISO 1133 | g/10 min | 22 | 22 |
| Specific Gravity | ISO 1183 | | 1-1.05 | 1.05 |
| Ash Content | ISO 3451 | % | 17-21 | 20.5 |
| Tensile at Yield | ISO 527, | MPa | 17 min | 19 |
| | 5 mm/min | | | |
| Flex Modulus | ISO 178, | MPa | 1150-1500 | 1436 |
| | 2 mm/min, | | | |
| | Chord | | | |
| MAI at 23° C. | ASTM D3763, | J | 15 min | 100% |
| | 2.2 m/sec | | | Ductile |
| | (Energy at | | | 17 |
| | max load) | | | |
| MAI at −30° C. | ASTM D3763, | J | 15 min | 100% |
| | 2.2 m/sec | | | Ductile |
| | (Energy at | | | 21 |
| | max load) | | | |
| CLTE | ASTM E831 | E-05/° C. | 4.4-5.0 | 5.1 |
| | −30° C. to | | | |
| | 100° C. | | | |

### Example 17

The masterbatch composition of Example 1 (MB1, 53% by weight) was combined with a blend of Basell Pro-fax® PH 920S (37%) and BP Amoco Acctuf® 3541 (10%) to meet OEM specifications. The resulting filled material exhibited the properties reported in Table 13.

TABLE 13

| | | | Target OEM | Final |
|---|---|---|---|---|
| Property | Test Method | Units | Specifications | Product |
| Melt Flow Rate | ASTM D1238, | g/10 min | 10-12 | 11.1 |
| | 230/2.16 | | | |
| Specific Gravity | ASTM D792 | | 1.05-1.13 | 1.08 |
| Mineral Filler | ASTM D2584 | % | 22-28 | 24.8 |
| Tensile at Yield | ASTM D638 | MPa | 10 min | 21 |
| Flex Modulus | ASTM D790 tg | MPa | 1000-1500 | 1483 |
| MAI at 23° C. | ASTM D3763, | J | 100% | 100% |
| | 2.2 m/sec | | Ductile | Ductile |
| | (Energy at | | 12 min | 19 |
| | max load) | | | |
| MAI at −15° C. | ASTM D3763, | J | 100% | 100% |
| | 2.2 m/sec | | Ductile | Ductile |
| | (Energy at | | 18 min | 23 |
| | max load) | | | |
| MAI at −30 | ASTM D3763, | J | | 100% |
| −30° C. | 2.2 m/sec | | | Ductile |
| | (Energy at | | | 23 |
| | max load) | | | |
| Mold Shrinkage | ASTM D955 | in/in | 0.5%-0.9% | 0.77 |
| | 24 hours | | | |
| | after molding | | | |
| | After 60 min | | 0.7%-1.1% | 0.89 |
| | at 125° C. | | | |
| CLTE 10⁻⁶ | ASTM E831, | in/in ° C. | 46 max | 37 |
| | −30° C. to | | | |
| | 100° C. | | | |

The present invention is not to be limited in scope by the specific embodiments described herein. Indeed, various modifications of the invention in addition to those described herein will become apparent to those skilled in the art from the foregoing description.

All patents, applications, publications, test methods, literature, and other materials cited herein are hereby incorporated by reference.

1. A filler masterbatch composition comprising a mineral filler and a polymer selected from an impact polypropylene, a high density polyethylene, and a polyolefin elastomer.

2. The filler masterbatch composition of claim 1, wherein the mineral filler is selected from talc, calcium carbonates, carbon black, mica, silica, and nanocomposites.

3. The filler masterbatch composition of claim 1, wherein the filler content is from 20-90% by weight.

4. The filler masterbatch composition of claim 1, wherein the polymer is a polyolefin elastomer.

5. The filler masterbatch composition of claim 4, wherein the polyolefin elastomer is a thermoplastic elastomer.

6. The filler masterbatch composition of claim 1, wherein the polymer is an ultra high impact polypropylene.

7. The filler masterbatch composition of claim 1, wherein the polymer is a high density polyethylene.

8. The filler masterbatch composition of claim 1, wherein the polymer content is from 20-90% by weight.

9. The filler masterbatch composition of claim 1, further comprising a dispersing agent.

10. The filler masterbatch composition of claim 9, wherein the dispersing agent is a wax or a metal salt.

11. The filler masterbatch composition of claim 9, wherein the dispersing agent content is from 0.15-5% by weight.

12. The filler masterbatch composition of claim 1, further comprising an antioxidant.

13. The filler masterbatch composition of claim 12, wherein the antioxidant content is from 01-11% by weight.

14. The filler masterbatch composition of claim 1, further comprising a UV additive.

15. The filler masterbatch composition of claim 14, wherein the UV additive is a hindered amine light stabilizer.

16. The filler masterbatch composition of claim 14, wherein the UV additive content is from 2-10% by weight.

17. The filler masterbatch composition of claim 1, further comprising a colorant.

18. The filler masterbatch composition of claim 17, wherein the colorant content is from 2-40% by weight.

19. The filler masterbatch composition of claim 17, wherein the colorant is selected from carbon black, pigments, specialty coated micas, aluminum flake, and dyes.

20. The filler masterbatch composition of claim 17, further comprising a UV additive.

21. The filler masterbatch composition of claim 20, wherein the UV additive content is from 2-10% by weight.

22. The filler masterbatch composition of claim 1, wherein the composition comprises about 20% to 90% mineral filler, about 20% to 90% thermal plastic elastomer, about 0.15% to 5% dispersing agent, and about 0.1% to 11% antioxidant.

23. The filler masterbatch composition of claim 1, wherein the composition comprises about 20% to 90% mineral filler, about 20% to 90% ultra high impact polypropylene, about 0.15% to 5% dispersing agent, about 0.1% to 11% antioxidant, and about 2 to 10% UV additives.

24. The filler masterbatch composition of claim 1, wherein the composition comprises about 20% to 90% mineral filler, about 20% to 90% high density polyethylene, about 0.15% to 5% dispersing agent, and about 0.1% to 11% antioxidant.

25. A process for producing a filler masterbatch composition comprising melt blending a mineral filler, a polymer, and, optionally, a dispersing agent, colorant, stabilizer, and/or process aid.

26. A process for producing a filled thermoplastic olefin composition comprising blending a filler masterbatch composition comprising a mineral filler, and a polymer selected from an impact polypropylene, a high density polyethylene, and a polyolefin elastomer with a thermoplastic olefin composition.

27. The process of claim 26, wherein the masterbatch composition and the thermoplastic olefin are melt blended.

28. The process of claim 27, wherein the masterbatch composition and the thermoplastic olefin are in-line compounded.

29. The process of claim 27, wherein the process is carried out using a single screw or twin screw extruder.

30. The process of claim 26, wherein the masterbatch composition and the thermoplastic olefin are dry blended and then subjected to a process which is carried out using polymer conversion equipment selected from injection molding, blow molding, cast film, profile extrusion, cast sheet, and post thermoforming equipment.

31. A process for producing a filled thermoplastic olefin composition, comprising blending a first filler masterbatch composition comprising a mineral filler and a polymer selected from an impact polypropylene, a high density polyethylene, and a polyolefin elastomer and a second filler masterbatch composition comprising a mineral filler; a polymer selected from an impact polypropylene, a high density polyethylene, and a polyolefin elastomer; a colorant; and additives selected from UV additives, UV stabilizers, and mixtures with a thermoplastic olefin composition.
